(19) United States
(12) Patent Application Publication
(10) Pub. No.: US 2007/0053767 A1
(43) Pub. Date: Mar. 8, 2007

(54) Nut jacket for vehicle

(76) Inventor: Mao Chin Chen, Yongkang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/511,244

(22) Filed: Aug. 29, 2006

(30) Foreign Application Priority Data
Sep. 5, 2005 (TW) 094215189
Sep. 5, 2005 (TW) 094215188

(51) Int. Cl. F16B 37/14

(52) U.S. Cl. 411/429

(57) ABSTRACT

A nut jacket for a vehicle includes at least one tubular coupling section and an outer member. The tubular coupling section includes an inner end with an opening and an outer end. The tubular coupling section is made of soft, tough material and mounted around a nut used on a vehicle. The outer member is mounted to the outer end of the tubular coupling section. A layer of reflective coating or a reflective member may be provided on inner or outer periphery of the outer member. The outer member may be transparent and a lamp is mounted in the outer member for emitting light through the outer member.

### BACKGROUND OF THE INVENTION

1. Field of the Invention

The present invention relates to a nut jacket and, more particularly, to a nut jacket for a nut used on a vehicle.

2. Description of the Related Art

Screws and nuts used on a vehicle are only for tightening purposes without any additional functions, such as the screws and nuts for tightening the wheels of a vehicle. For safety consideration, lamps are provided on front and rear of a vehicle for illumination and alarm purposes to prevent accidents. Reflective painting and/or reflective stickers are also provided on two sides of a vehicle to avoid from being hit from the side. However, the wheels that are located at a lower position and that are important for steering are often ignored in illumination and/or alarming. Although some drivers provide a reflective painting or reflective stickers on a surface of a wheel cover, most drivers do not.

### SUMMARY OF THE INVENTION

In accordance with an aspect of the present invention, a nut jacket for a vehicle comprises at least one tubular coupling section and an outer member. The at least one tubular coupling section includes an inner end with an opening and an outer end. The at least one tubular coupling section is made of soft, tough material and adapted to be mounted around at least one nut used on a vehicle. The outer member is mounted to the outer end of the at least one tubular coupling section.

Preferably, the nut jacket further comprises alarm means provided on the outer member.

In an example, the at least one tubular coupling section includes at least one slit.

In another example, at least one resilient coil member is mounted around the at least one tubular coupling section.

In a further example, the outer member includes a layer of reflective coating on an inner periphery or an outer periphery of the outer member.

In still another example, the outer member includes a reflective member mounted to an inner periphery or an outer periphery thereof.

In yet another example, the outer member is transparent, and a lamp is mounted in the outer member for emitting light through the outer member.

In still another example, the outer member and the at least one tubular coupling section are integrally formed with each other.

In yet another example, the at least one nut is mounted on a wheel of the vehicle, and a collar is mounted between the at least one tubular coupling section and the wheel to enhance coupling tightness and to prevent entrance of water and dust.

In still another example, the at least one tubular coupling section includes a first, open end and a second, closed end. A first engaging member is provided on the second, closed end of the at least one tubular coupling section. The outer member includes a second engaging member for engaging with the first engaging member. In an example, the first engaging member is a stud and the second engaging member is a screw hole. The nut jacket for a vehicle as claimed in claim 1 wherein the outer member further includes a decorative member attached to an outer periphery thereof.

In yet another example, the at least one tubular coupling section includes a hexagonal inner perimeter.

In still another example, there are more than one tubular coupling section commonly connected to the outer member.

In accordance with another aspect of the present invention, a nut jacket for a vehicle comprises a plurality of tubular coupling sections and an outer member. Each tubular coupling section includes an inner end with an opening and an outer end. Each tubular coupling section is adapted to be mounted around an associated one of a plurality of nuts used on a vehicle. The outer member is mounted to the ends of the tubular coupling sections.

Other objectives, advantages, and features of the invention will become more apparent from the following detailed description when taken in conjunction with the accompanying drawings.

### BRIEF DESCRIPTION OF THE DRAWINGS

FIG. 1 is a perspective view of an embodiment of a nut jacket for a vehicle in accordance with the present invention.

FIG. 2 is an exploded perspective view of the nut jacket in FIG. 1.

FIG. 3 is a sectional view of the embodiment of the nut jacket in accordance with the present invention.

FIG. 4 is a sectional view of a modified embodiment of the nut jacket in accordance with the present invention.

FIG. 5 is a sectional view of another modified embodiment of the nut jacket in accordance with the present invention.

FIG. 6 is a perspective view illustrating use of the nut jacket in accordance with the present invention.

FIG. 7 is an enlarged sectional view illustrating coupling of the nut jacket in accordance with the present invention with a nut used on a wheel of a vehicle.

FIG. 8 is an exploded perspective view illustrating a further modified embodiment of the nut jacket in accordance with the present invention.

FIG. 9 is a perspective view of the nut jacket in FIG. 8.

FIG. 10 is a sectional view of a still another modified embodiment of the nut jacket in accordance with the present invention.

FIG. 11 is a sectional view of yet another modified embodiment of the nut jacket in accordance with the present invention.

### DETAILED DESCRIPTION OF THE PREFERRED EMBODIMENTS

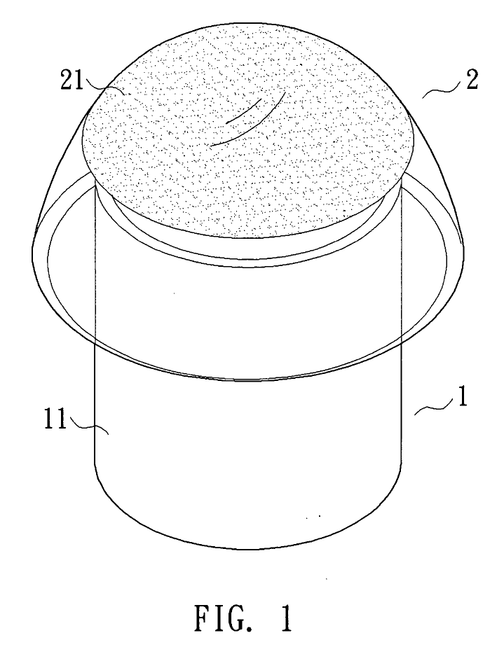

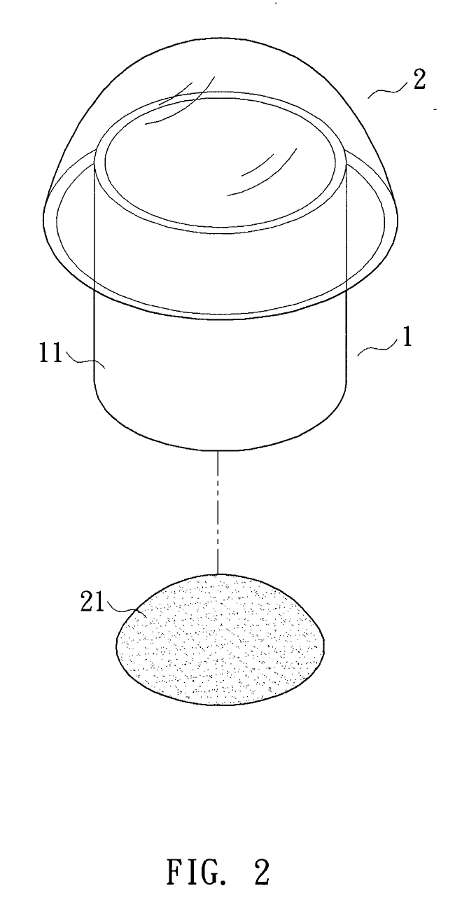

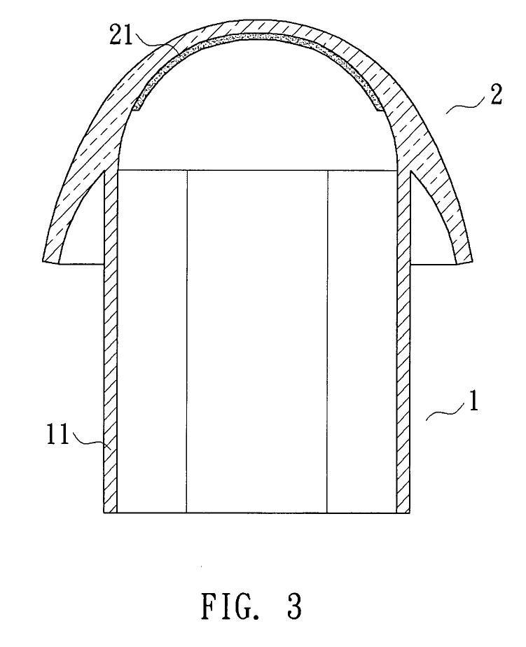

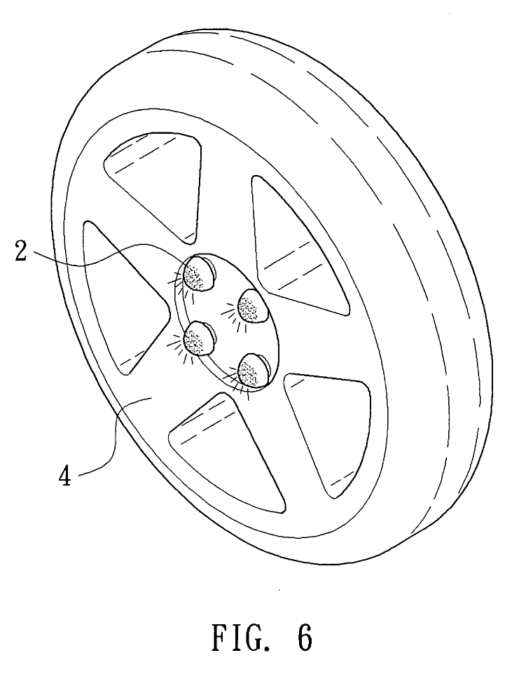

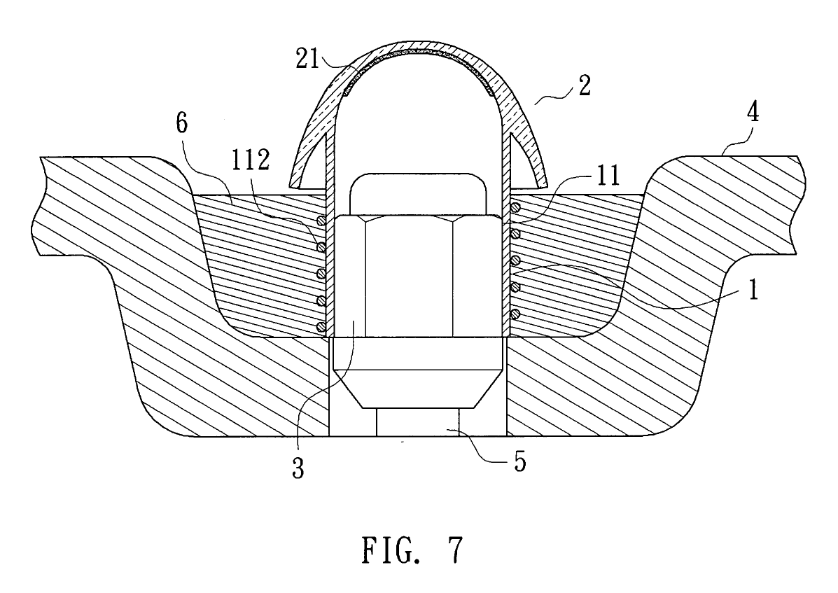

Referring to FIGS. 1 through 3, an embodiment of a nut jacket for a vehicle in accordance with the present invention comprises a coupling section 1 and an outer member 2 formed on an outer end of the coupling section 1. In this embodiment, the coupling section 1 is a tubular member 11 having an opening in an inner end thereof for mounting around a nut 3 that is engaged on a screw or bolt 5 mounted to a wheel 4 of a vehicle (see FIGS. 6 and 7). A collar 6 may be mounted between the tubular member 11 and the wheel 1 to enhance the tightening effect while avoiding entrance of water and dust. With reference to FIG. 7, the tubular member 11 may include an inner, hexagonal perimeter corresponding to the hexagonal perimeter of the nut 3.

With reference to FIGS. 1 through 3, the outer member 2 in this embodiment is integrally formed on the outer end of the coupling section 1. The outer member 2 may be domed and made of transparent material. Preferably, a reflective member 21 is attached to an inner periphery of the outer member 2. Alternatively, the reflective member 21 may be provided on an outer periphery of the outer member 2. Hence, incident lights from another vehicle to the nut jacket on the vehicle will be reflected to the driver of another vehicle, providing an alarming effect, which is quite useful when the two vehicles are moving crosswise or one of the vehicles are turning. The coupling section 1 has an outer diameter the same as or slightly smaller than that of the nut 3. The coupling section 1 is made of soft, tough material. Hence, when mounting the coupling section 1 to the nut 3, the coupling section 1 slightly expands radially outward, allowing easy mounting of the nut jacket onto the nut 3.

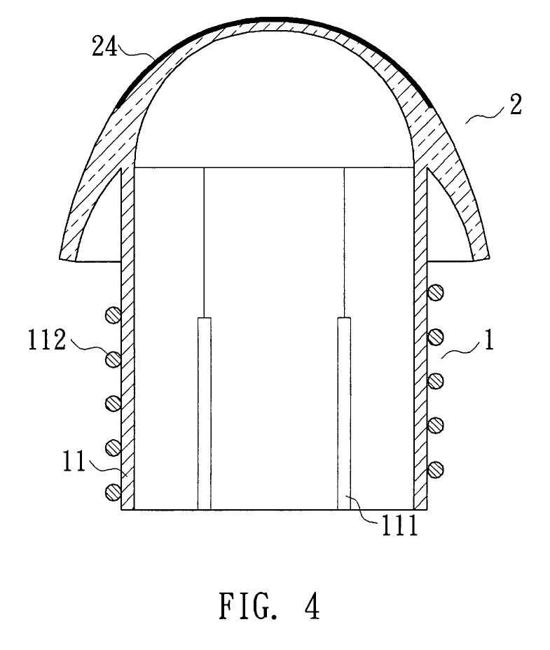

In a modified embodiment shown in FIG. 4, a layer of reflective coating 24 is applied on the outer periphery of the outer member 2. Alternatively, the reflective coating 24 is applied on the inner periphery of the outer member 2. A similar alarming effect is provided. Further, at least one resilient coil member 112 is mounted around the coupling section 11 to provide enhanced tightening effect, as shown in FIGS. 4 and 7.

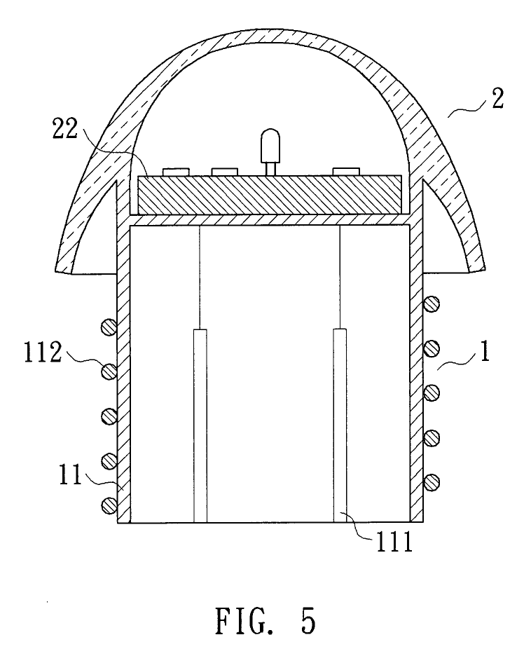

In another modified embodiment shown in FIG. 5, a lighting device 22 having a light (not labeled) is mounted in the outer member 2 and emits light via the outer member 2 that is preferably transparent, providing an alarm effect (see FIG. 6). Further, the tubular member 11 may include at least one longitudinal slit 111 to allow elastic expansion in a radial direction when the nut jacket is mounted around the nut 3.

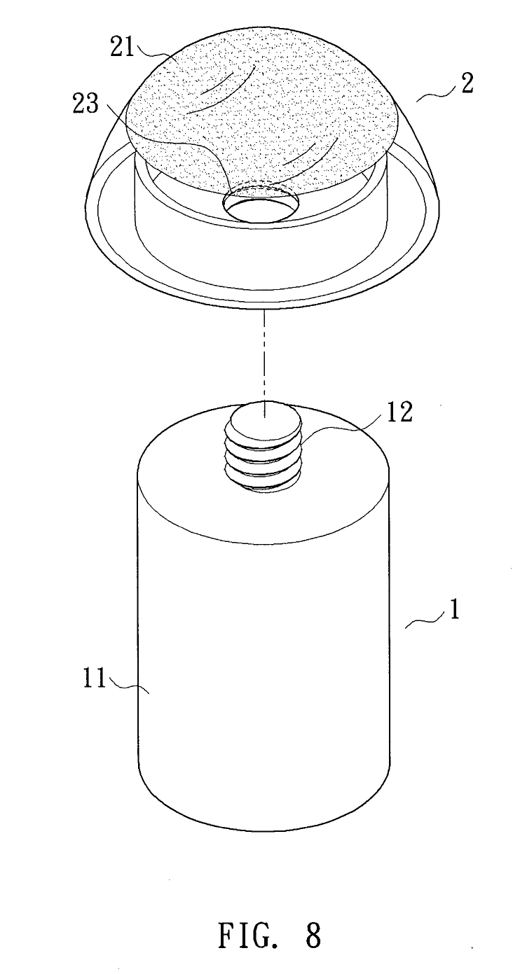

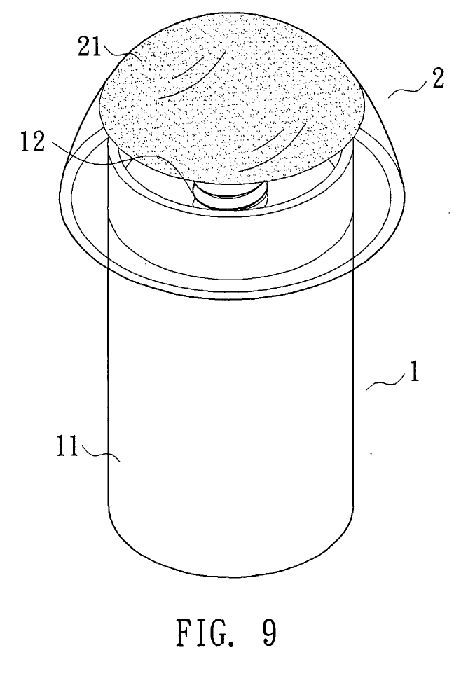

In a further modified embodiment shown in FIGS. 8 and 9, the outer member 2 is separate from the coupling section 1. More specifically, the tubular member 11 includes a first, open end and a second, closed end on which a stud 12 is provided for coupling with a screw hole 23 in the outer member 2. A reflective member 21 may be attached to the inner or outer periphery of the outer member 2.

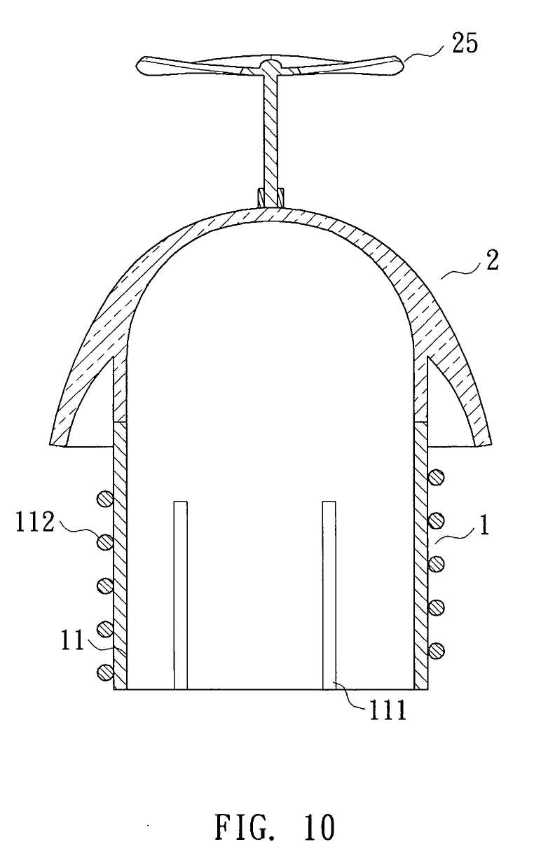

In a still another modified embodiment shown in FIG. 10, a decorative fan blade 25 is attached to the outer member 2 for decorative purposes. Further, trademark, marking, or other aesthetic patterns can be provided on the outer member 2.

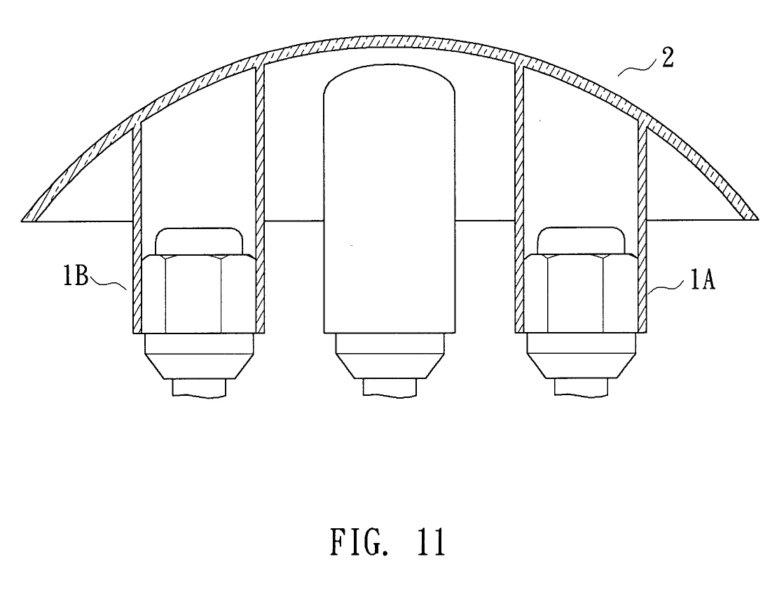

In yet another modified embodiment shown in FIG. 11, the nut jacket includes a common outer portion 2 and more than one (e.g., four) coupling section (see 1A and 1B) for coupling with, e.g., four nuts (not labeled) on a wheel 4.

Although specific embodiments have been illustrated and described, numerous modifications and variations are still possible. The scope of the invention is limited by the accompanying claims.

What is claimed is:

1. A nut jacket for a vehicle, comprising:
at least one tubular coupling section including an inner end with an opening and an outer end, said at least one tubular coupling section being made of soft, tough material and adapted to be mounted around at least one nut used on a vehicle; and
an outer member mounted to the outer end of said at least one tubular coupling section.

2. The nut jacket for a vehicle as claimed in claim 1 further comprising alarm means provided on the outer member.

3. The nut jacket for a vehicle as claimed in claim 1 wherein said at least one tubular coupling section includes at least one slit.

4. The nut jacket for a vehicle as claimed in claim 1 further comprising at least one resilient coil member mounted around said at least one tubular coupling section.

5. The nut jacket for a vehicle as claimed in claim 2 wherein the outer member includes a layer of reflective coating on one of an inner periphery and an outer periphery of the outer member.

6. The nut jacket for a vehicle as claimed in claim 2 wherein the outer member includes a reflective member mounted to an inner periphery thereof.

7. The nut jacket for a vehicle as claimed in claim 2 wherein the outer member includes a reflective member mounted to an outer periphery thereof.

8. The nut jacket for a vehicle as claimed in claim 2 wherein the outer member is transparent, further comprising a lamp mounted in the outer member for emitting light through the outer member.

9. The nut jacket for a vehicle as claimed in claim 1 wherein the outer member and said at least one tubular coupling section are integrally formed with each other.

10. The nut jacket for a vehicle as claimed in claim 1 wherein said at least one nut is mounted on a wheel of the vehicle, further comprising a collar between said at least one tubular coupling section and the wheel to enhance coupling tightness and to prevent entrance of water and dust.

11. The nut jacket for a vehicle as claimed in claim 1 wherein the said at least one tubular coupling section includes a first, open end and a second, closed end, a first engaging member being provided on the second, closed end of said at least one tubular coupling section, the outer member including a second engaging member for engaging with the first engaging member.

12. The nut jacket for a vehicle as claimed in claim 1 wherein the first engaging member is a stud and wherein the second engaging member is a screw hole.

13. The nut jacket for a vehicle as claimed in claim 1 wherein the outer member further includes a decorative member attached to an outer periphery thereof.

14. The nut jacket for a vehicle as claimed in claim 1 wherein said at least one tubular coupling section includes a hexagonal inner perimeter.

15. The nut jacket for a vehicle as claimed in claim 1 wherein a number of said at least one tubular coupling section is more than one, said tubular coupling sections being connected to the outer member.

16. A nut jacket for a vehicle, comprising:
a plurality of tubular coupling sections each including an inner end with an opening and an outer end, each tubular coupling section being adapted to be mounted around an associated one of a plurality of nuts used on a vehicle; and
an outer member mounted to the ends of said tubular coupling sections.

17. The nut jacket for a vehicle as claimed in claim 16 wherein the outer member includes a layer of reflective coating on one of an inner periphery and an outer periphery of the outer member.

18. The nut jacket for a vehicle as claimed in claim 16 wherein the outer member is transparent and includes a reflective member mounted to an inner periphery thereof.

19. The nut jacket for a vehicle as claimed in claim 16 wherein the outer member includes a reflective member mounted to an outer periphery thereof.

20. The nut jacket for a vehicle as claimed in claim 16 wherein the outer member is transparent, further comprising a lamp mounted in the outer member for emitting light through the outer member.
